(19) United States
(12) Patent Application Publication
(10) Pub. No.: US 2009/0230363 A1
(43) Pub. Date: Sep. 17, 2009

(54) POLYMER COMPOSITE

(75) Inventors: Eun Sung LEE, Seoul (KR); Sang Mock LEE, Yongin-si (KR); Young Hun BYUN, Yongin-si (KR)

Correspondence Address: CANTOR COLBURN, LLP, 20 Church Street, 22nd Floor, Hartford, CT, 06103, US

(73) Assignee: SAMSUNG ELECTRO-MECHANICS CO., LTD., Suwon-si (KR)

(21) Appl. No.: 12/397,987

(22) Filed: Mar. 4, 2009

Related U.S. Application Data
(63) Continuation-in-part of application No. 12/130,441, filed on May 30, 2008.

(30) Foreign Application Priority Data
Nov. 14, 2007 (KR) 10-2007-0115981

(51) Int. Cl. H01B 1/02; H01B 1/08

(52) U.S. Cl. 252/512; 252/518.1; 977/742; 977/762

(57) ABSTRACT

A polymer composite having a high dielectric constant is disclosed herein. The polymer composite includes a conductive material impregnated with oxidizable metal nanoparticles or metal oxide nanoparticles to decrease dielectric loss, and an anion surfactant containing an acidic functional group to form a passivation layer that surrounds the conductive material, resulting in increased dielectric constant.

This application is a continuation-in-part of copending U.S. patent application Ser. No. 12/130,441, filed on May 30, 2008, which claims priority to Korean Patent Application No. 2007-115981, filed on Nov. 14, 2007, and all the benefits accruing therefrom under 35 U.S.C. § 119, the content of which is incorporated herein by reference in its entirety.

### BACKGROUND

1. Field

This disclosure is directed to a polymer composite, and more particularly, to a polymer composite, which comprises a conductive material impregnated with oxidizable metal nanoparticles or metal oxide, an anion surfactant containing an acidic functional group, and a polymer resin, thus realizing a high dielectric constant.

2. Description of the Related Art

According to recent trends in electronic products industry, mobile electronics are dominating technological development and markets. Thus, intensive and extensive research and development have been made to decrease the size and weight of mobile products and increase the performance thereof.

In order to realize high-density surface mounting, a substrate is required to have fine via-holes and as small a wiring pitch as possible, and must be capable of being subjected to a fabrication process. Further, IC packages should be miniaturized, pluralities of pins should be used, and passive parts, including condensers and resistors, should be miniaturized and surface-mounted. However, with the advancement of the miniaturization of passive devices, the manufacture and mounting thereof become more difficult, and thus the conventional process has many limitations.

To overcome such limitations, there have been proposed techniques for directly forming passive devices on or in a printed circuit board (“PCB”), instead of mounting them on the PCB. These techniques for embedding passive devices are characterized in that passive devices are disposed outside or inside the substrate using new materials and processes, thereby substituting for the functions of conventional chip resistors and chip capacitors. Accordingly, there is no need for chip parts of the passive devices to be mounted on the printed wiring board, thus realizing high density and high reliability. As the passive devices are embedded in the PCB through such techniques, the surface area of the substrate can be decreased, thereby making it possible to decrease the size and weight of products. Further, inductance is reduced, to thereby improve electrical performance, and furthermore, the number of solder joints is decreased, therefore increasing apparatus reliability and reducing the manufacturing cost.

Among the passive devices, the resistor and inductor, which may be formed through a polymer thick film (“PTF”) process, have some design drawbacks, but entail no great difficulty in terms of materials and manufacturing processes. However, in the case of the capacitor, it cannot be applied to fields requiring a high capacity, because a material having high capacitance and a manufacturing process for applying the material to a low-temperature process (i.e., less than about 260° C.) are not commercially available. Typically, embedded condensers require capacity ranging from 1 pF to 1 μF, depending on the applications thereof. When a thin film process is used, high capacity may be achieved, but high-temperature annealing should be carried out. Furthermore, the ceramic thin film produced may easily break down when applied to an organic substrate. Further, the application to FR-4 or flex substrates is also limited, causing high cost of the manufacturing process. In contrast, the PTF process may be performed easily and inexpensively and may ensure high applicability to an organic substrate, but results in low dielectric capacity.

### SUMMARY

It is therefore desirable to achieve a high dielectric constant by use of the PTF process. Accordingly, disclosed herein is, in an embodiment, a polymer composite having a high dielectric constant and a low heat loss.

Also disclosed herein is a capacitor comprising the polymer composite.

Also in an embodiment, a polymer composite is provided. The polymer composite comprises a conductive material impregnated with oxidizable metal nanoparticles or metal oxide nanoparticles; an anion surfactant containing an acidic functional group; and a polymer resin.

The anion surfactant containing an acidic functional group may be one or more selected from the group consisting of monomers or oligomers having an acidic functional group, and polymeric surfactants obtained by polymerizing a monomer having an acidic functional group with another monomer having an alkyl group or an ethylene oxide group. The acidic functional group of the anion surfactant may be one or more selected from the group consisting of —COOH, —CH₂COOH, —OCH₂COOH, —OH, —PO₄H₂, —PO₃H, —PO₄H⁻, —SH, —SO₃H, and —SO₄H. The monomer having an acidic functional group is a monomer in which the number of carbons is C₂-C₂₀ while containing the acidic functional group, and the oligomer having an acidic functional group derived therefrom has a number averaged molecular weight of about 500 to about 5,000 g/mol.

The conductive material may be one or more selected from the group consisting of carbon black, carbon nanotubes, carbon nanowires, carbon fibers, and graphite.

The polymer composite may have a dielectric loss of 50% or less as measured at a frequency of 1 MHz, and a dielectric constant of about 1,000 or more as measured at a frequency of 1 MHz.

In another embodiment, a capacitor comprising the polymer composite is provided.

In another embodiment, a dielectric comprises the cure product of a polymer composite comprising a conductive material impregnated with oxidizable metal nanoparticles or metal oxide nanoparticles; an anion surfactant containing an acidic functional group; and a polymer resin.

In still another embodiment, a dielectric structure comprises the dielectric.

### BRIEF DESCRIPTION OF THE DRAWINGS

The exemplary embodiments will be more clearly understood from the following detailed description taken in conjunction with the accompanying drawings, in which:

FIG. 1 is a schematic view showing a polymer composite;

FIG. 2 is a transmission electron micrograph (“TEM”) illustrating an exemplary conductive material prepared in Preparative Example 1;

FIG. 3 is a scanning transmission electron micrograph (“STEM”) illustrating the exemplary conductive material prepared in Preparative Example 1;

FIG. 4 is a graph illustrating the results of energy dispersive X-ray (“EDX”) analysis of the exemplary conductive material prepared in Preparative Example 1; and

FIG. 5 is a proton nuclear magnetic resonance (“NMR”) spectrum of an exemplary surfactant prepared in Preparative Example 1.

### DETAILED DESCRIPTION

Hereinafter, a detailed description will be given of example embodiments with reference to the accompanying drawings.

As used herein, the singular forms “a,” “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In accordance with one embodiment, a polymer composite comprises a conductive material impregnated with oxidizable metal nanoparticles or metal oxide nanoparticles; an anion surfactant containing an acidic functional group; and a polymer resin. In another embodiment, a dielectric comprises the cure product of the polymer composite. In still another embodiment, a dielectric structure (e.g., layer, film, sheet, board, or the like) comprises the dielectric. Also in an embodiment, a method of preparing a dielectric structure having a high dielectric constant comprises enlarging the effective area or increasing the capacitance (i.e., the effective dielectric constant) of the structure using a dielectric material having a high dielectric constant. When a material having an interconnected structure, such as carbon black, is used as a conductive material instead of metal powder, it functions as an electrode when dispersed in a polymer resin, thus enlarging the electrode area of the dielectric. In this case, although the interface between the conductive material and the polymer resin plays a role in enlarging the effective area, it also results in a dielectric loss (tan δ) of the dielectric. Hence, in one embodiment, the dielectric loss is decreased by impregnating the conductive material with oxidizable metal nanoparticles or metal oxide nanoparticles. In this case, however, the dielectric constant also decreases along with the decrease in the dielectric loss. This is because, although the conductive material is isolated by the oxidized film resulting from the impregnated metal nanoparticles or oxide to decrease the dielectric loss, it is not sufficient to serve as an electrode, and thus capacitance is not increased in proportion to the increase in the effective electrode area. Thus, in an embodiment, a dielectric comprising the cure product of the polymer composite has decreased dielectric loss when compared with a conductive material without oxidizable metal nanoparticles or metal oxide nanoparticles impregnating the conductive material.

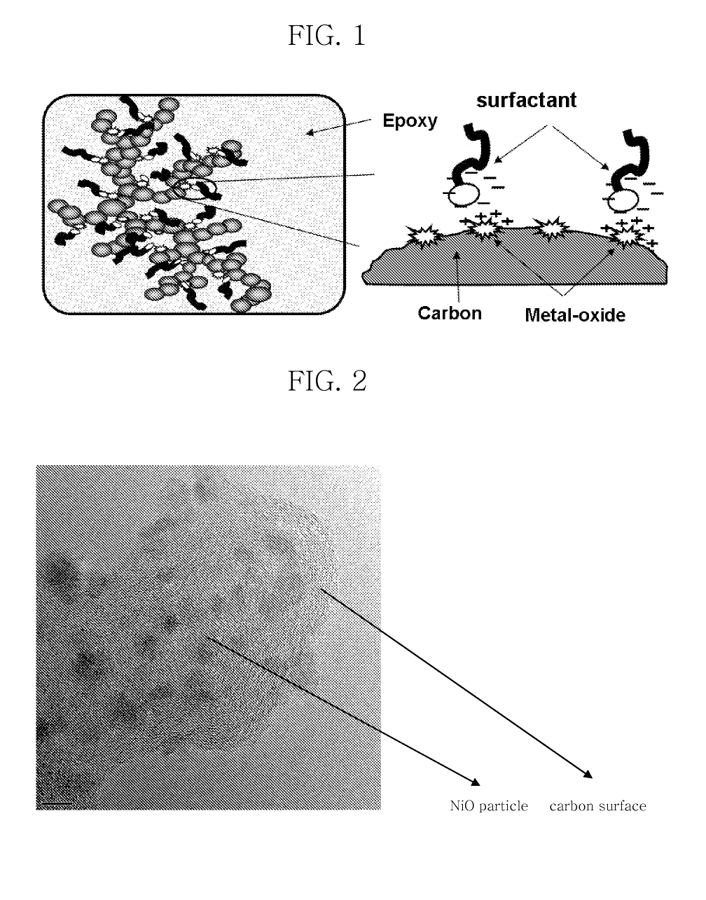

Accordingly, in order to prevent the decrease in the dielectric constant, which accompanies the decrease in the dielectric loss, an anion surfactant containing an acidic functional group is additionally used to form a passivation layer that surrounds the conductive material in the polymer resin. Thereby, electrical conduction or percolation, which may be caused by contact between the particles of the conductive material, is prevented, thereby minimizing the decrease in the capacitance of the dielectric. As shown in FIG. 1, which depicts an illustrative composite of conductive carbon particles (e.g., carbon black, graphite, etc.) with metal or metal oxide nanoparticles thereon and anion surfactant in a polymer (e.g., epoxy) matrix, the anion surfactant may form an ionic salt with the metal nanoparticles or metal oxide nanoparticles supported on the surface of the conductive material (e.g., conductive carbon particles), thus increasing the capacitance of the polymer composite.

The polymer composite thus includes the conductive material impregnated with oxidizable metal nanoparticles or metal oxide nanoparticles, which increases the effective area and simultaneously decreases the dielectric loss. The polymer composite further includes the anion surfactant containing an acidic functional group, to thereby increase the dielectric capacitance and thus resulting in a dielectric composite having a high dielectric constant. Accordingly, the dielectric constant and the dielectric loss may be adjusted separately and independently by adjusting the amount and type of anion surfactant and the amount of oxidizable metal nanoparticle.

Below, individual components of the polymer composite are described in greater detail.

Conductive Material Impregnated with Oxidizable Metal Nanoparticles or Metal Oxide Nanoparticles

The polymer composite includes a conductive material impregnated with oxidizable metal nanoparticles or metal oxide nanoparticles. As the conductive material, a material having an interconnected structure, such as carbon black, is used instead of metal powder, thus enlarging the electrode area of the dielectric structure prepared from the polymer composite. Further, in order to decrease the dielectric loss of the dielectric, the conductive material is impregnated with the oxidizable metal nanoparticles or metal oxide nanoparticles.

The conductive material includes carbon black, carbon nanotubes, carbon nanowires, carbon fibers, graphite, or a mixture thereof. In the case where the conductive material as above is used, a higher dielectric constant may be obtained.

The metal nanoparticles or metal oxide nanoparticles, which are impregnated on the conductive material, include an easily oxidizable material such as a base metal. Examples of the base metal include, but are not limited to, one or more selected from the group consisting of nickel, zinc, copper, iron, mercury, silver, platinum, gold, tin, lead, aluminum, oxides thereof, and mixtures thereof.

### Anion Surfactant

The polymer composite includes an anion surfactant containing an acidic functional group.

The anion surfactant may contain one or more acidic functional groups selected from the group consisting of —COOH, —CH₂COOH, —OCH₂COOH, —OH, —PO₄H₂, —PO₃H, —PO₄H⁻, —SH, —SO₃H, and —SO₄H.

The anion surfactant containing an acidic functional group may be a monomer or an oligomer having an acidic functional group, or may be a polymeric surfactant obtained by polymerizing a monomer having an acidic functional group with another monomer having an alkyl group or an ethyleneoxide group.

The acidic functional group has a high affinity for the oxidizable metal material, thus forming a chemical bond by a reaction therebetween and forming an ionic salt with metal nanoparticles or metal oxide nanoparticles supported on the surface of the conductive material, thereby resulting in the formation of a passivation layer that surrounds the conductive material. Because the anion surfactant containing the acidic functional group forms the passivation layer that surrounds the conductive material, such as carbon black or carbon nanotubes, in the polymer resin, electrical conduction or percolation due to contact between the particles of the conductive material is prevented, thereby providing a high dielectric constant.

Where the anion surfactant is a polymeric surfactant obtained by polymerizing a monomer having an acidic functional group with another monomer having an alkyl group or an ethyleneoxide group, the polymeric surfactant includes not only the acidic functional group which has a high affinity for the oxidizable metal material but also a repeating unit having one or more hydrophilic or hydrophobic side chains which have a high affinity for the polymer resin in the polymer composite. The acidic functional group, having a high affinity for the oxidizable metal material, may form a chemical bond through a reaction therebetween. Because the repeating unit having one or more hydrophilic or hydrophobic side chains has a high affinity for the polymer resin, in the polymer-conductive material composite, the surfactant is linked with the conductive material impregnated with metal oxide and is combined with the polymer resin, thus forming a passivation layer that surrounds the conductive material. In this way, electrical conduction or percolation which could occur as a result of contact between the particles of the conductive material is prevented, thus ensuring a high dielectric constant and a low dielectric loss.

The acidic functional group of the anion surfactant is linked with the conductive material impregnated with the metal oxide nanoparticles through a chemical reaction. The anion surfactant molecules are thereby arranged around the conductive material, and the non-acidic portion of the anion surfactant molecules, having affinity for the polymer resin, radially extend from the acidic functional group, so that the conductive material is efficiently dispersed in the dispersion medium. In an exemplary embodiment of the chemical reaction, acid-base interaction between acidic group —PO₄H₂, which is a functional group of the surfactant, and nanoparticles of NiO, which is impregnated on the conductive material, an ionic salt is formed. In particular, the acidic functional group of the surfactant (e.g., —PO₄H₂, which may also be written as —OPO(OH)₂) which acts as a ferroelectric component does not bind with an acidic conductive material such as carbon black and thus the anion surfactant does not function as a passivation layer in such a combination. However, in the composite including the conductive material impregnated with the oxidizable metal nanoparticles or metal oxide particles, strong acid-base interaction occurs between the metal nanoparticles or metal oxide nanoparticles, which are impregnated in and on the conductive material, and the ferroelectric (acidic) functional group of the surfactant, thus allowing introduction of the ferroelectric acidic functional group of the surfactant to the surface of the conducting material, thereby increasing the dielectric constant of the polymer composite.

The monomer containing the acidic functional group may be one or more selected from the group consisting of n-tetradecyl phosphonic acid, acetyl phosphoric acid, octyl phenol ethoxylated phosphoric acid, octyl phenol ethoxylated carboxylic acid.

Examples of polymeric anion surfactant include, but are not limited to, repeating units comprising acidic functional groups represented by Formulas 1 and 2 below:

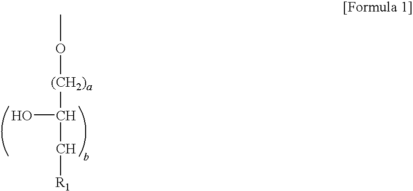

wherein R₁ is one or more selected from the group consisting of —COOH, —CH₂COOH, —OCH₂COOH, —OH, —PO₄H₂, —PO₃H, —PO₄H⁻, —SH, —SO₃H, and —SO₄H; a ranges from 0 to 5; and b ranges from 0 to 10, where at least one of a and b is 1.

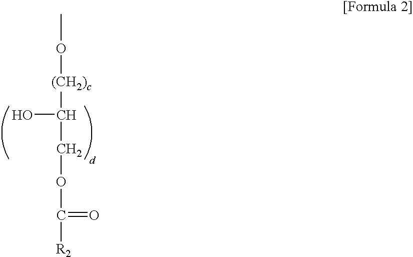

wherein R₂ is one or more selected from the group consisting of —COOH, —CH₂COOH, —OCH₂COOH, —OH, —PO₄H₂, —PO₃H, —PO₄H⁻, —SH, —SO₃H, and —SO₄H; c ranges from 0 to 5; and d ranges from 0 to 10, where at least one of c and d is 1.

Examples of the backbone of the surfactant include, but are not limited to, one or more selected from the group consisting of polyacryl, polyurethane, polystyrene, polysiloxane, polyether, polyisobutylene, polypropylene, and polyepoxy.

Examples of the polymeric surfactant include, but are not limited to, one or more repeating units selected from the group consisting of compounds represented by Formulas 3 and 4 below:

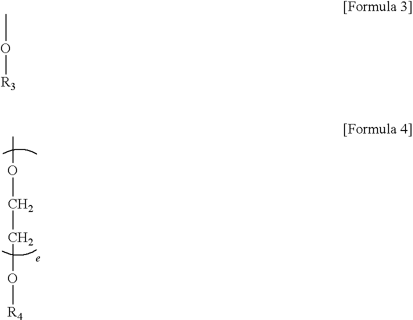

in Formulas 3 and 4, R₃ is a C_{1˜30} alkyl group, a C_{2˜30} alkene group, or a C_{2˜30} alkyne group; R₄ is a C_{1˜10}-alkyl group, a C_{2˜10} alkene group, a C_{2˜10} alkyne group, or a C_{6˜30} aryl group; and e ranges from 1 to 20.

The backbone of the polymeric surfactant may be, but is not limited to, one or more selected from the group consisting of polyacryl, polyurethane, polystyrene, polysiloxane, polyether, polyisobutylene, polypropylene, and polyepoxy.

The polymeric surfactant of the exemplary embodiments may be represented by Formula 5 below:

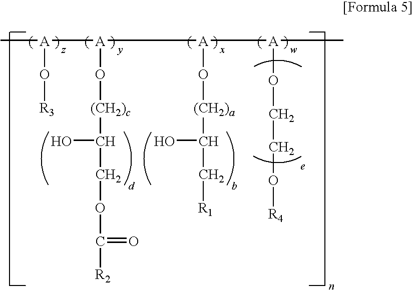

wherein each A is independently acryl, urethane, styrene, siloxane, ether, isobutylene, propylene or epoxy backbone; R₁ and R₂ are each one or more selected from the group consisting of —COOH, —CH₂COOH, —OCH₂COOH, —OH, —PO₄H₂, —PO₃H, —PO₄H⁻, —SH, —SO₃H, and —SO₄H; R₃ is a C_{1˜30} alkyl group, a C_{2˜30} alkene group, or a C_{2˜30} alkyne group; R₄ is a C_{1˜10} alkyl group, a C_{2˜10} alkene group, a C_{2˜10} alkyne group, or a C_{6˜30} aryl group; x, y, z and w each ranges from 0 to 50, each repeating unit is randomly arranged; a and c range from 1 to 5; b and d range from 1 to 10; e ranges from 1 to 20; and n ranges from 1 to 50.

Examples of the surfactant include, but are not limited to, compounds represented by Formulas 6 and 10 below:

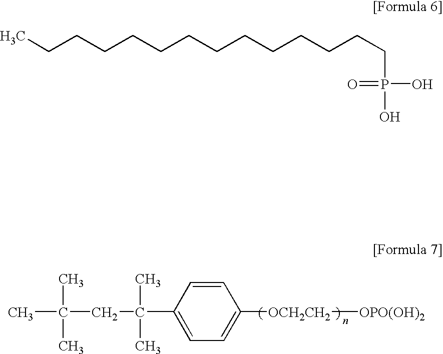

wherein n ranges from 2 to 10.

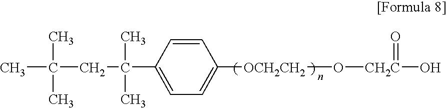

wherein n ranges from 2 to 10.

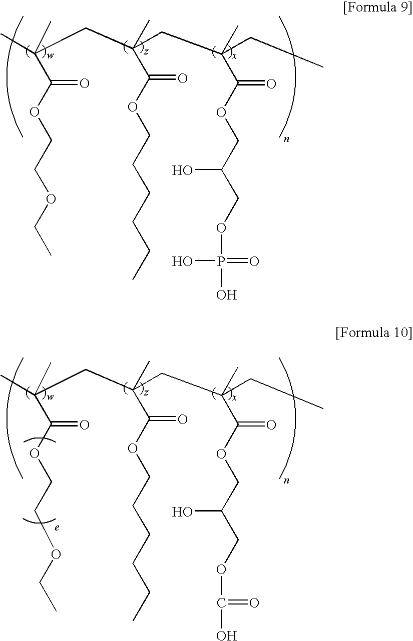

wherein in Formulas 9 and 10, x, y and z each range from 1 to 50, where each repeating unit is randomly arranged; and n ranges from 1 to 50.

The surfactant has a number averaged molecular weight (Mn) of about 200 to about 5,000 g/mol, specifically about 500 to about 5,000 g/mol.

The surfactant may be prepared by reacting one or more compounds selected from compounds represented by Formulas II and 12 with a compound represented by Formula 13 in the presence of a polymerization initiator or catalyst, thereby obtaining a copolymer. Then, the resulting copolymer is reacted with a compound containing the acidic functional group in the presence of an acid catalyst to include one or more acidic functional groups in the copolymer.

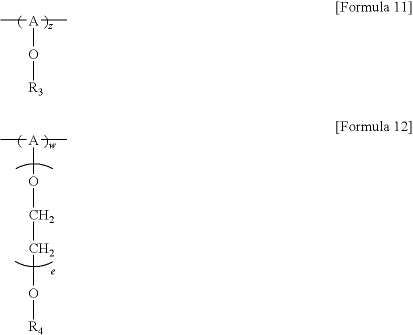

wherein, in Formulas 11 and 12, each A is independently acryl, urethane, styrene, siloxane, ether, isobutylene, propylene or epoxy backbone; R₃ is a C_{1˜30} alkyl group, a C_{2˜30} alkene group, or a C_{2˜30} alkyne group; R₄ is a C_{1˜10}-alkyl group, a C_{2˜10} alkene group, a C_{2˜10} alkyne group, or a C_{6˜30} aryl group; z and w each ranges from 1 to 50; and e ranges from 1 to 20.

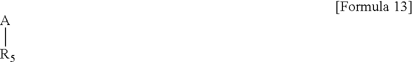

Here, A is acryl, urethane, styrene, siloxane, ether, isobutylene, propylene or epoxy backbone; and R₅ is an epoxy group substituted with a C_{1˜10}-alkyl group, a C_{2˜10} alkene group, a C_{2˜10} alkyne group, or a C_{6˜30} aryl group.

Examples of the monomer containing one or more acidic functional groups include, but are not limited to, one or more selected from the group consisting of thiol compounds, phosphoric acid compounds, and sulfonic acid compounds.

Examples of the polymerization initiator include, but are not limited to, methyl trimethylsilyl dimethylketene acetal, potassium persulfate, hydrogen peroxide, cumyl hydroperoxide, di-tert butyl peroxide, dilauryl peroxide, acetyl peroxide, benzoyl peroxide, and azobisisobutyronitrile (“AIBN”).

Hereafter, a method of synthesizing the surfactant is described in greater detail. As shown in Reaction 1 below, as monomers, polyethylene glycol methacrylate, hexyl methacrylate, and glycidyl methacrylate for reaction with the acidic functional group are subjected to Group Transfer Polymerization (“GTP”), thereby synthesizing a portion of the surfactant. In this case, in order to change the type of side chain thereof, a starting material containing a different type of side chain may be used.

The synthesized portion is reacted with the above monomer containing the acidic functional group to thereby obtain the surfactant, in which the acidic functional groups are connected to the backbones. The reaction is conducted through the additional reaction of an epoxy group and an acid in the presence of an acid or an ammonium salt catalyst. In Reaction 1 below, the monomer containing the acidic functional group is exemplified by phosphoric acid (H₃PO₄) or phosphorus pentoxide (P₂O₅) The reaction is performed at a temperature ranging from room temperature to 130° C. for a period of time ranging from 30 minutes to 15 hours under atmospheric pressure, followed by conducting heating and refluxing and removing the solvent at reduced pressure, thereby obtaining a desired surfactant.

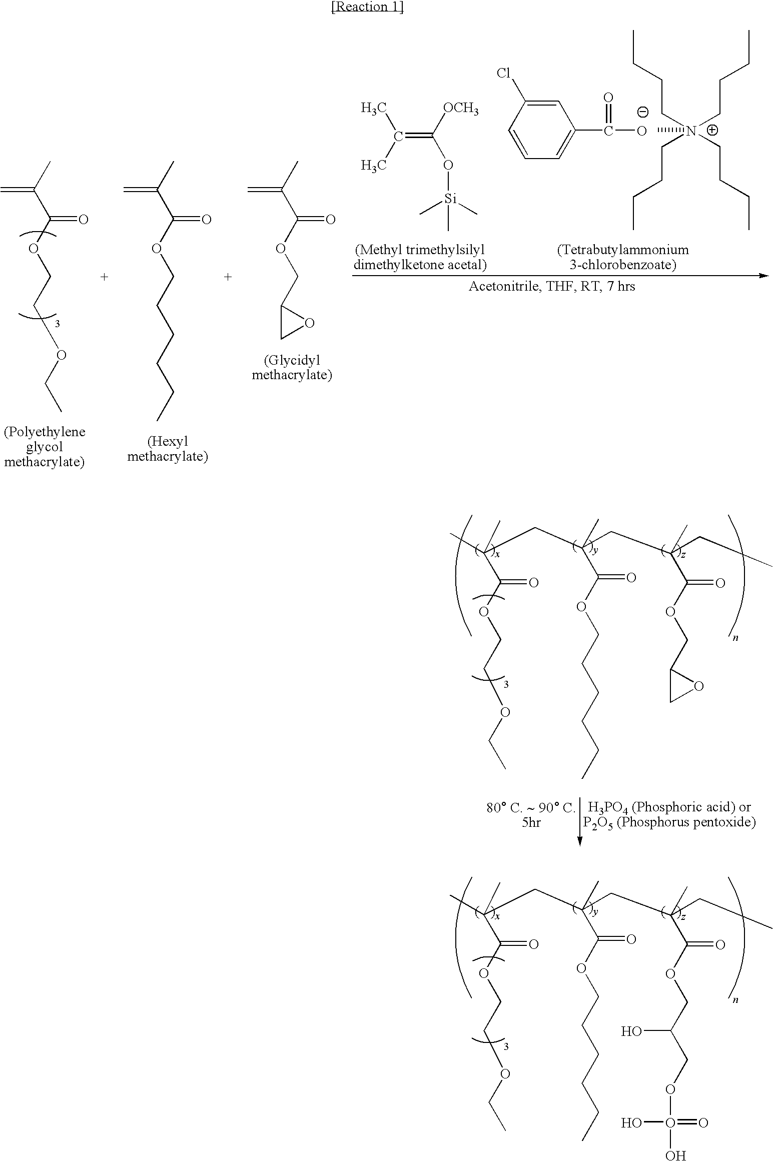

The surfactant is used in an amount of 10 to 80 parts by weight based on 100 parts by weight of the conductive material.

### Polymer Resin

Examples of the polymer resin included in the polymer composite include, but are not limited to, one or more selected from the group consisting of epoxy, polyimide, silicon polyimide, silicone, polyurethane, benzocyclobutene.

The polymer resin is used in an amount of 50 to 99 vol % based on the total volume of the polymer composite.

A binder or other organic additive may be added to the polymer composite. Further, a urethane-based compound may be added thereto. Where an aromatic urethane-based compound is added, it is believed that the aromatic rings may form a bond by dispersive forces, e.g. by π-π stacking, on the surface of the conductive material (e.g. on the surface of carbon when the conductive material is carbon black) other than the surface regions occupied by metal nanoparticles or the metal oxide nanoparticles in the conductive material impregnated with metal nanoparticles or metal oxide nanoparticles. Thus, a passivation layer that surrounds the conductive material may additionally be formed on the surfactant containing the acidic functional group. Thereby, electrical conduction or percolation, which may otherwise occur as a result of contact between the particles of the conductive material, is prevented, thus minimizing the dielectric loss of the dielectric material. The urethane-based compound may therefore perform essentially the same function on the exposed surfaces of the conductive material as that of the surfactant acting on the surface of the conductive material. The urethane-based compound is not particularly limited, but examples thereof include DISPERBYK®-164, DISPERBYK®-163, DISPERBYK®-2150, DISPERBYK®-2155, and or the like, commercially available from BYK-Chemie (Germany).

The polymer composite is prepared by mixing the conductive material, the surfactant, and the polymer resin using a stirring device or a mixing device, such as a sonicator, a homogenizer, a spiral mixer, a planetary mixer, a disperser, or a hybrid mixer and curing thereafter. The polymer composite may be formed into a film, sheet, layer, or other form and cured to form a dielectric material by a low-temperature process of about 200° C. or less.

To facilitate processing, the polymer composite is mixed with a solvent. Thereafter, the resultant mixture may be applied, prior to curing, to a substrate by a coating process, including spin coating, electrophoretic deposition, casting, ink-jet printing, spraying, or off-set printing.

The polymer composite may have a dielectric loss of about 150% or less as measured at a frequency of 1 MHz. In an embodiment, the dielectric loss may be about 50% or less. In a specific embodiment, the dielectric loss may be about 10% or less. Also in an embodiment, the polymer composite may have the dielectric constant of about 1,000 or more, as measured at a frequency of 1 MHz. In a specific embodiment, the polymer composite may have the dielectric loss of about 50% or less and a dielectric constant of about 5,000 or more, as measured at a frequency of 1 MHz. In another specific embodiment, the polymer composite may have a dielectric loss of about 20% or less and the dielectric constant of about 1000 or more.

In another embodiment, the polymer composite is used to form a capacitor. In the capacitor, the cure product of the polymer composite (i.e., the dielectric material) is used as a dielectric between electrodes facing each other (i.e., where the electrodes are planar, cofacial electrodes with the dielectric material disposed therebetween). The polymer composite can be applied not only to formation of a general capacitor structure but also to that of a laminated capacitor structure.

The polymer composite may be used for capacitors, and may also be used as material for fabricating electron guns or electrodes of field emission displays (“FEDs”), material for transparent electrodes of FEDs or liquid crystal displays, and light-emitting material, buffering material, electron transporting material, and hole transporting material for organic electroluminescence devices.

A better understanding of the exemplary embodiments will be described in more detail with reference to the following examples, which are for the purpose of illustration only and are not to be construed as limiting the scope of the invention.

### EXAMPLES

### Preparative Example 1

### Synthesis of Carbon Black Impregnated with NiO Nanoparticles

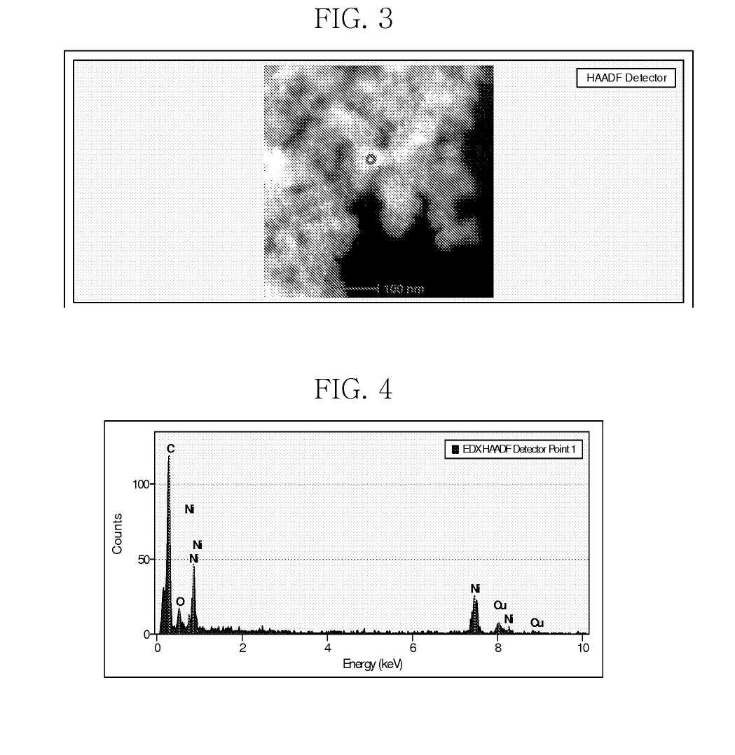

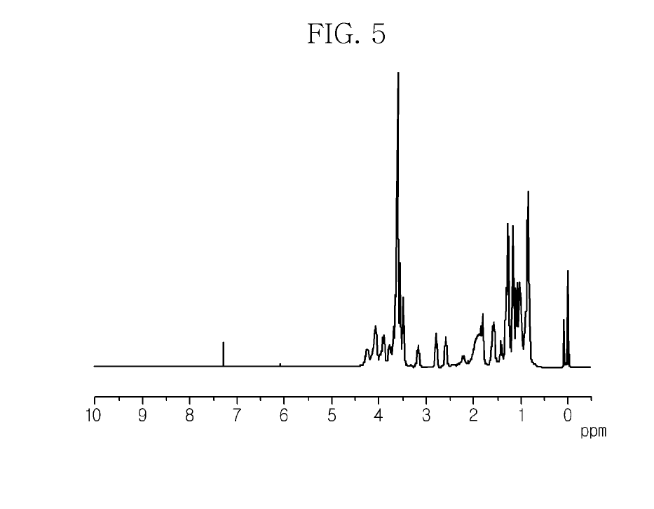

100 ml of acetonitrile was added to 2 g of carbon black (Ketjen black 300, Mitsubishi) to prepare a slurry solution. 2.478 g (8.52 mmol) of Ni(NO₃)₂.6H₂O and 0.52 g (8.52 mmol) of ethanolamine were dissolved in 100 ml of acetonitrile. This solution was added to the slurry solution such that the amount of Ni was 20 wt % based on the amount of carbon black. Thereafter, stirring was conducted for 2 hours at the room temperature. Subsequently, the solvent was removed using a rotary evaporator at room temperature, thus obtaining carbon black in which the Ni sol compound was uniformly distributed. Thereafter, the resulting composition was baked at 400° C. for 7 hours in a nitrogen atmosphere, to afford 2.5 g of carbon black impregnated with Ni or NiO. A transmission electron microscopy (TEM) micrograph of the carbon black so impregnated with Ni or NiO is shown in FIG. 2, and a scanning transmission electron microscopy (“STEM”) micrograph thereof is shown in FIG. 3. The results of energy dispersive X-ray (“EDX”) analysis of the carbon black are shown in FIG. 4.

It can be seen from FIGS. 2 to 4 that the carbon black is uniformly impregnated with Ni or NiO nanoparticles having an average particle size (longest dimension) measurable in nanometers (maximum: up to 10 nm).

### Preparative Example 2

Carbon black impregnated with NiO nanoparticles was manufactured in the same manner as in Preparative Example 1, with the exception that carbon black (Ketjen black 600, Mitsubishi) was used in lieu of carbon black (Ketjen black 300, Mitsubishi), and Ni(NO₃)₂.6H₂O was used in an amount of 2.668 g.

### Example 1

1.064 g of 3,4-epoxycyclohexylmethyl-3,4-epoxycyclohexanecarboxylate (Aldrich), 1.064 g of diglycidyl ether of bisphenol A (“DEGBA”), 0.964 g of tetrahydrophthalic anhydride, 0.053 g of DISPERBYK®-164 surfactant, 0.015 g of 1-methyl imidazole (Aldrich), 0.228 g of the carbon black impregnated with NiO prepared as above in Preparative Example 1 and 0.023 g of tetradecyl phosphonic acid as a surfactant (“TDPA”; Alfa-Aesar)were mixed for 6 hours and cured for 1 hour at 180° C. to thereby preparing a paste. The 1-methyl imidazole was used in an amount of 0.02 equivalents based on the total amount of epoxy resin components.

### Examples 2 and 3

Pastes were prepared in the same manner as in Example 1, with the exception that curing was performed for 2 hours and 3 hours, respectively.

### Example 4

A paste was prepared in the same manner as in Example 1, with the exception that 1-methyl imidazole was used in an amount of 0.01 equivalents based on the total amount of epoxy resin components, and curing was performed at 160° C. for 2 hours followed by 180° C. for 1 hour.

### Example 5

A paste was prepared in the same manner as in Example 4, with the exception that 0.09 g of a urethane-based surfactant (DISPERBYK®-164, available from BYK-Chemie, Germany) was also added to the composition.

### Example 6

A paste was prepared in the same manner as in Example 1, with the exception that the carbon black of Preparative Example 2 was used in lieu of the carbon black impregnated with NiO nanoparticles of Preparative Example 1, and curing was performed at 160° C. for 2 hours and then at 180° C. for 1 hour.

### Example 7

A paste was prepared in the same manner as in Example 1, with the exception that 1-methyl imidazole was used in an amount of 0.01 equivalents based on the amount of epoxy resin, and curing was performed at 170° C. for 2 hours.

### Example 8

A paste was prepared in the same manner as in Example 7, with the exception that 1-methyl imidazole was used in an amount of 0.02 equivalents based on the amount of epoxy resin.

### Comparative Example 1

A composite was prepared in the same manner as in Example 1, with the exception that carbon black (Ketjen black 300, available from Mitsubishi), which is a non-metal or metal oxide-impregnated conductive material, was used, and the surfactant was not added.

### Comparative Example 2

A composite was prepared in the same manner as in Example 1, with the exception that the surfactant was not added.

The dielectric constant and the dielectric loss of the composites obtained in Example 1 and Comparative Examples 1 and 2 were measured for an average measurement time of 4 sec/point at a frequency ranging from 10 kHz to 10 MHz using a Hewlett-Packard HP 4194A impedance analyzer. Under conditions where the applied voltage was set within the range from −3.0 to 3.0 V and the applied voltage interval was set to 0.10 V, capacitance was measured. Then, the dielectric constant was calculated using the following equations. In particular, the dielectric constant and the dielectric loss of the Examples 1 to 8 and the Comparative Examples 1 to 2 were measured at a frequency of 1 MHz. The results are shown in Table 1 below.

C=∈₀×S/d

S: electrode surface=0.785 mm²

d: electrode to electrode distance=20-30 μm

∈₀: dielectric constant in a vacuum=8.854×10⁻¹² [F/m] Table 1 below shows the dielectric constant, the dielectric loss and capacitance of the composites obtained in Examples 1 to 8 and Comparative Examples 1 and 2.

TABLE 1

| | | | | Dielectric | Dielectric |
|---|---|---|---|---|---|
| | Run No. | Capacitance(F) | | Constant | Loss (%) |
| Ex. 1 | 1 | 1.21 | n | 5208 | 45.6 |
| | 2 | 1.16 | n | 5014 | 42.7 |
| Ex. 2 | 1 | 935 | p | 3364 | 54.4 |
| | 2 | 760 | p | 2733 | 43.6 |
| Ex. 3 | 1 | 674 | p | 3204 | 52.3 |
| | 2 | 731 | p | 3473 | 64.7 |
| Ex. 4 | 1 | 690 | p | 2098 | 49.8 |
| | 2 | 708 | p | 2153 | 62.3 |
| Ex. 5 | 1 | 479 | p | 1580 | 69.4 |
| | 2 | 408 | p | 1356 | 54.4 |
| Ex. 6 | 1 | 2.43 | n | 8047 | 112.1 |
| | 2 | 1.87 | n | 6198 | 109.7 |
| Ex. 7 | 1 | 943 | p | 2947 | 41.8 |
| | 2 | 972 | p | 3038 | 41.0 |
| Ex. 8 | 1 | 674 | p | 3204 | 52.3 |
| | 2 | 731 | p | 3473 | 64.7 |
| Comp. Ex. 1 | 1 | 160 | p | 569 | 37.4 |
| | 2 | 170 | p | 679 | 47.7 |
| Comp. Ex. 2 | 1 | 103 | p | 296 | 61.7 |
| | 2 | 149 | p | 470 | 69.5 |

As is apparent from Table 1, the impregnating effect of the conductive material and the effect of the surfactant containing the acidic functional group can be seen. In Comparative Example 1 using the non-impregnated carbon black without the surfactant, the dielectric constant was low. In Comparative Example 2 where the impregnated carbon black was used, the dielectric loss was decreased but the dielectric constant was considerably decreased. However, in Examples 1 to 8 where both the impregnated carbon black and the surfactant were used, it can be seen that the dielectric constant was high and the dielectric loss was relatively decreased.

That is, the polymer composite includes the conductive material impregnated with the oxidizable metal nanoparticles or metal oxide nanoparticles, thus decreasing the dielectric loss. Furthermore, the surfactant containing the acidic functional group is included, and thus a passivation layer is formed so as to surround the conductive material, thereby preventing the generation of electrical conduction or percolation due to contact between the particles of the conductive material. Thus, a high dielectric constant can be achieved. Therefore, the polymer composite may be used to realize superior capacitors, and may contribute to a decrease in the size and weight of mobile electronic devices.

Although exemplary embodiments have been disclosed for illustrative purposes, those skilled in the art will appreciate that various modifications, additions and substitutions are possible, without departing from the scope and spirit of the invention as defined by the appended claims.

1. A polymer composite, comprising:
a conductive material impregnated with oxidizable metal nanoparticles or metal oxide nanoparticles;
an anion surfactant containing an acidic functional group; and
a polymer resin.

2. The polymer composite of claim 1, wherein the anion surfactant containing an acidic functional group comprises one or more surfactants selected from the group consisting of one or more monomers or oligomers containing an acidic functional group, and one or more polymeric surfactants obtained by polymerizing a monomer containing an acidic functional group with a monomer including an alkyl group or an ethylene oxide group.

3. The polymer composite of claim 1, wherein the metal nanoparticles or metal oxide nanoparticles comprise one or more base metals selected from the group consisting of nickel, zinc, copper, iron, mercury, silver, platinum, gold, tin, lead, aluminum, oxides thereof, and mixtures thereof.

4. The polymer composite of claim 1, wherein the conductive material comprises one or more selected from the group consisting of carbon black, carbon nanotubes, carbon nanowires, carbon fiber, and graphite.

5. The polymer composite of claim 1, wherein the acidic functional group of the anion surfactant comprises one or more selected from the group consisting of —COOH, —CH₂COOH, —OCH₂COOH, —OH—PO₄H₂, —PO₃H, —PO₄H⁻, —SH, —SO₃H, and —SO₄H.

6. The polymer composite of claim 2, wherein the monomer containing an acidic functional group comprises one or more selected from the group consisting of n-tetradecyl phosphonic acid, acetyl phosphoric acid, octyl phenol ethoxylated phosphoric acid, and octyl phenol ethoxylated carboxylic acid.

7. The polymer composite of claim 2, wherein the polymeric surfactant comprises one or more repeating units selected from the group consisting of compounds represented by Formulas 1 and 2 below: 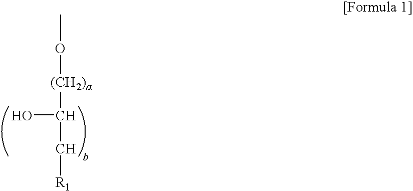
wherein R₁ is one or more selected from the group consisting of —COOH, —CH₂COOH, —OCH₂COOH, —OCH₂COOH, —OH, —PO₄H₂, —PO₃H, —PO₄H⁻, —SH, —SO₃H, and —SO₄H,
a ranges from 0 to 5, and
b ranges from 0 to 10,
where at least one of a or b is 1; and 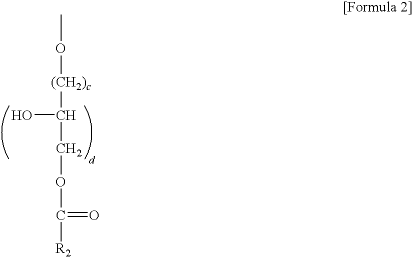
wherein R₂ is one or more selected from the group consisting of —COOH, —CH₂COOH, —OCH₂COOH, —OH, —PO₄H₂, —PO₃H, —PO₄H⁻, —SH, —SO₃H, and —SO₄H,
c ranges from 0 to 5, and
d ranges from 0 to 10,
where at least one of c or d is 1.

8. The polymer composite of claim 1, wherein the polymeric surfactant comprises one or more repeating units selected from the group consisting of compounds represented by Formulas 3 and 4 below: 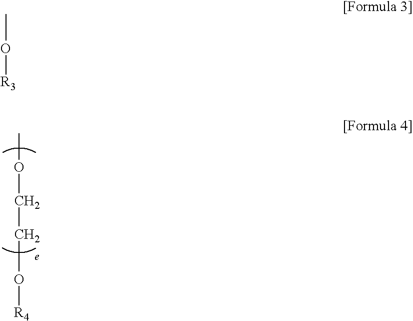
in Formulas 3 and 4, R₃ is a C_{1˜30} alkyl group, a C_{2˜30} alkene group, or a C_{2˜30} alkyne group,
R₄ is a C_{1˜10} alkyl group, a C_{2˜10} alkene group, a C_{2˜10} alkyne group, or a C_{6˜30} aryl group, and
e ranges from 1 to 20.

9. The polymer composite of claim 1, wherein the polymeric surfactant is represented by Formula 5 below: 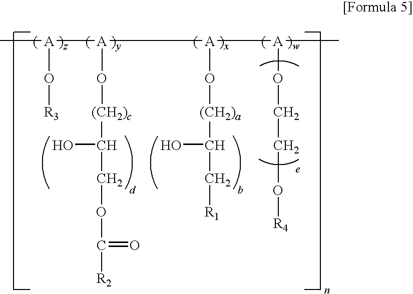
wherein each A is independently acryl, urethane, styrene, siloxane, ether, isobutylene, propylene or epoxy backbone,
R₁ and R₂ are each one or more selected from the group consisting of —COOH, —CH₂COOH, —OCH₂COOH, —OH, —PO₄H₂, —PO₃H, —PO₄H⁻, —SH, —SO₃H, and —SO₄H,
R₃ is a C_{1˜30} alkyl group, a C_{2˜30} alkene group, or a C_{2˜30} alkyne group,
R₄ is a C_{1˜10} alkyl group, a C_{2˜10} alkene group, a C_{2˜10} alkyne group, or a C_{6˜30} aryl group,
x, y, z and w each ranges from 0 to 50, each repeating unit is randomly arranged,
a and c range from 1 to 5,
b and d range from 1 to 10,
e ranges from 1 to 20, and
n ranges from 1 to 50.

10. The polymer composite of claims 1, wherein the anion surfactant is represented by Formulas 6 and 10 below: 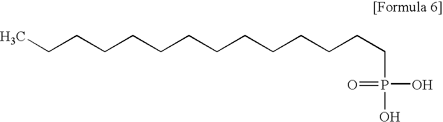 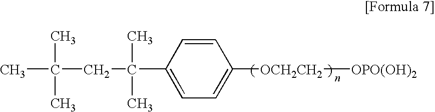
wherein n ranges from 2 to 10. 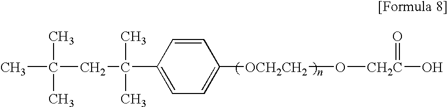
wherein n ranges from 2 to 10. 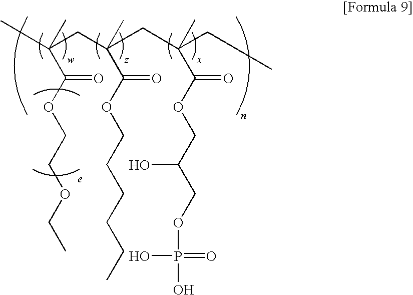
wherein x, y and z each ranges from 1 to 50, each repeating unit is randomly arranged, and
n ranges from 1 to 50. 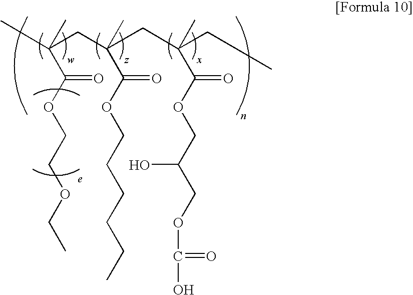
wherein x, y and z each ranges from 1 to 50, each repeating unit is randomly arranged, and
n ranges from 1 to 50.

11. The polymer composite of claim 1, wherein the anion surfactant has a number average molecular weight ranging from 200 to 5,000.

12. The polymer composite of claim 1, wherein the polymer resin is one or more selected from the group consisting of epoxy resin, polyimide resin, silicon polyimide resin, silicone resin, polyurethane, benzocyclobutene, and a mixture thereof.

13. The polymer composite of claim 1, wherein the anion surfactant is used in an amount of 10 to 80 parts by weight based on 100 parts by weight of the conductive material; and the polymer resin is used in an amount of 50 to 99 vol % based on a total volume of the polymer composite.

14. The polymer composite of claim 1 further comprising a urethane compound.

15. The polymer composite of claim 1, wherein the polymer composite has a dielectric loss of about 150% or less as measured at a frequency of 1 MHz.

16. The polymer composite of claim 15, wherein the polymer composite has a dielectric loss of about 50% or less as measured at a frequency of 1 MHz.

17. The polymer composite of claim 1, wherein the polymer composite has a dielectric constant of about 1,000 or more as measured at a frequency of 1 MHz.

18. The polymer composite of claim 1, wherein the polymer composite has a dielectric loss of about 50% or less and a dielectric constant of about 5,000 or more as measured at a frequency of 1 MHz.

19. The polymer composite of claim 1, wherein the polymer composite has a dielectric loss of about 20% or less and a dielectric constant of about 1,000 or more as measured at a frequency of 1 MHz.

20. A capacitor comprising the polymer composite of claim 1.

21. A dielectric comprising the cure product of:
a polymer composite comprising
a conductive material impregnated with oxidizable metal nanoparticles or metal oxide nanoparticles;
an anion surfactant containing an acidic functional group; and
a polymer resin.

22. The dielectric of claim 21, wherein the dielectric has decreased dielectric loss when compared with a conductive material without oxidizable metal nanoparticles or metal oxide nanoparticles impregnating the conductive material.

23. A dielectric structure comprising the dielectric of claim 21.
